(19) United States
(12) Patent Application Publication
(10) Pub. No.: US 2008/0028681 A1
(43) Pub. Date: Feb. 7, 2008

(54) Child Barrier with a Pressure Indicator

(76) Inventor: Jesper Andersen, Lasby (DK)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 11/793,062

(22) PCT Filed: Dec. 14, 2005
(86) PCT No.: PCT/DK05/00790

§ 371 Date: Aug. 8, 2007

(30) Foreign Application Priority Data
Dec. 17, 2004 (DK) BA200400328

(51) Int. Cl. G08B 19/00

(52) U.S. Cl. 49/13

(57) ABSTRACT

A child safety barrier (1) has a handle (8, 20, 21), which, when being operated, causes two upper ferrules (9, 10) to be fixed in an opening between two side posts (2, 3), as well as a pressure indicator which shows how great a pressure is provided against the side posts (2, 3). According to the invention, the pressure indicator is constructed as a pressure transducer in the form of a strain gauge (13) which is disposed on one of the upper ferrules (9). A signal processing circuit (16), which is powered from a battery (19), is connected to the strain gauge (13). The signal processing circuit (16) has a display unit which may be a light-emitting diode or a sound unit, which gives a signal when the pressure between the upper ferrules (9, 10) is sufficient. The display unit also shows whether the battery (19) is sufficient charged. The invention provides a pressure indicator which is more reliable than a mechanical pressure indicator, in particular after having been used for an extended period of time.

The invention relates to a child safety barrier which is formed by a gate having an upper cross member and a lower cross member, said upper cross member being connected with the lower cross member by a plurality of barrier bars, said upper cross member being provided with upper ferrules at its ends, at least one ferrule of which being secured to a rod which is movable relative to the upper cross member, and whose movement is provided by the operation of a handle, said movement of the rod causing the gate to be firmly fixed in an opening, e.g. defined by side posts, said child safety barrier having a pressure indicator which is adapted to show whether the child safety barrier is fixed sufficiently in the opening or the frame.

Such a child safety barrier is known from EP 1 331 352. This known child safety barrier is provided with a mechanical pressure indicator based on a spring which is fixed between a threaded rod of a ferrule and a fixed stop; in this case a side post. Two visible marks are provided on the threaded rod, which can be seen only if there is no sufficient pressure against the ferrule.

Such a mechanical indicator operates satisfactorily as long as the spring maintains its rigidity, but when the spring ages and becomes more slack, indication errors can occur, which means that there is insufficient pressure even though the marks cannot be seen.

Accordingly, an object of the invention is to ensure that a child safety barrier with a pressure indicator is always securely fixed in an opening when so shown by a display unit associated with the pressure indicator.

The object of the invention is achieved by a child safety barrier of the type defined in the introductory portion of claim 1, which is characterized in that the pressure indicator is a pressure transducer which is disposed on one of the ferrules.

Such a pressure indicator, which may expediently be a strain gauge, as stated in claim 2, is stable also after having been used for an extended period of time.

For use of the child safety barrier where domestic power is not available, which is the case in areas in many developing countries, it is advantageous if, as stated in claim 3, the strain gauge is powered from a battery which is positioned inside the upper cross member, and that wires between the strain gauge and the battery are run inside the upper cross member.

For easy operation, it is moreover an advantage if, as stated in claim 4, the voltage detected by the strain gauge is supplied to a display unit showing the amount of force with which the upper cross member is fixed in the opening.

Finally, enhanced security of the pressure indicator is achieved if, as stated in claim 5, the display unit shows the status of the voltage of the battery, and that an alarm signal is given if the voltage gets below a given minimum value.

The invention will now be explained more fully with reference to the drawing, in which

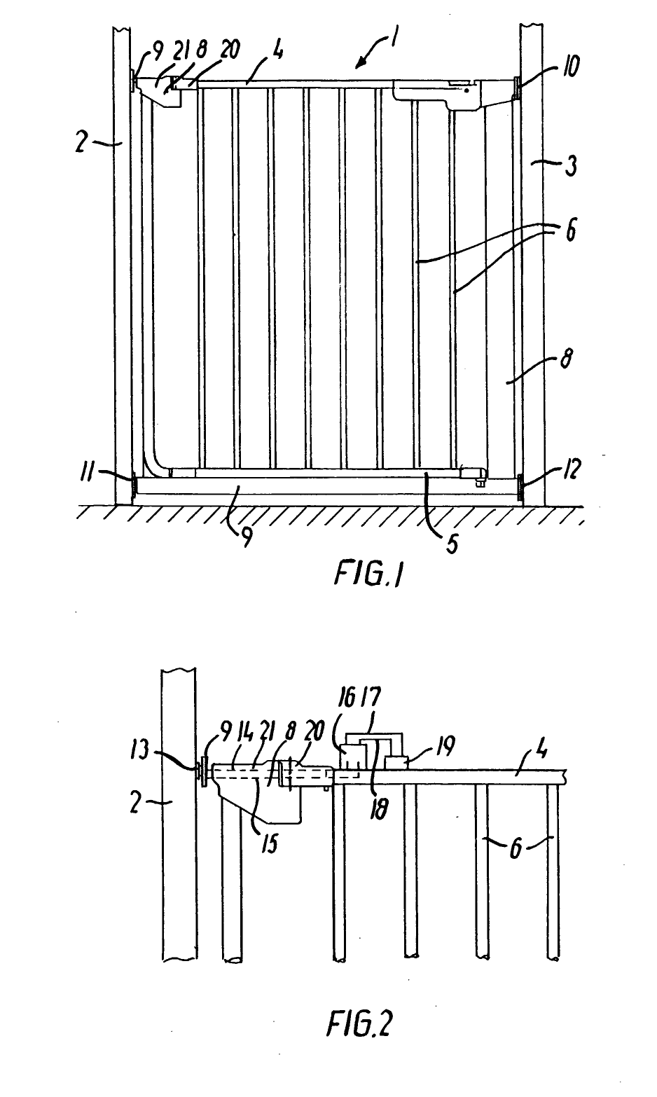

FIG. 1 shows a child safety barrier according to the invention, while

FIG. 2 shows an enlarged view of a portion of the child safety barrier in FIG. 1 with a pressure indicator according to the invention.

In FIG. 1, the numeral 1 generally designates a child safety barrier of the same type as described in e.g. EP 1 332 352.

The child safety barrier is composed of a gate which is here shown mounted in a frame formed by a right post 8 and a lower base member 9. The gate is composed of an upper cross member 4 and a lower cross member 5 between which a plurality of ribs are secured. The frame and the gate are fixed in an opening which is defined by two side posts 2, 3.

As will be seen, the frame is fixed against the side posts by means of an upper ferrule 10 and two lower ferrules 11, 12 mounted on displaceable rods (not shown), which may e.g. have threads engaging with threads in the upper cross member 4 and the lower cross member 5, respectively, so that the spacing between the ferrules is determined by the width of the opening between the side posts 2, 3.

The gate itself is also terminated at its left corner by an upper ferrule 9, which is also movable relative to a handle 8, said ferrule 9 being mounted on a threaded rod (not shown) in the handle 8.

In addition, the ferrule 9 may be displaced by the operation of the handle 8, which consists of two parts 20, 21, one part 20 of which when lifted up-wards will push the other part 21 and thereby the ferrule 9 back, while the opposite movement of the part 20 will push the part 21 and thereby the ferrule forwards toward the side post 2.

In brief, the child safety barrier operates in the following manner:

When the gate with frame is to be mounted in an opening, the lower ferrules 11, 12 are fixed against the side posts 2, 3 so that a secure pressure will be provided against these. Then, the part 20 is pulled upwards, and the upper ferrules 9, 10 are set so that a subsequent impact on the part 20 downwards on the handle 8 will provide a suitable tension of the upper ferrules 9, 10 against the side posts 2, 3. To ensure that there is sufficient fixing between the upper ferrules, a mechanical pressure indicator is arranged e.g. at one of the upper corners, said pressure indicator measuring the pressure between the upper ferrules, and a display unit showing whether the pressure is sufficient, may be arranged in connection with this.

The description above corresponds to what may be derived from the above-mentioned EP publication.

In relation to this, the pressure indicator is constructed as a pressure transducer, e.g. a strain gauge, which is designated 13 in FIG. 2 and is arranged on the surface of the ferrule.

Electrical wires are run through a hole in the ferrule 9 to a signal processing circuit 16, which is normally inserted in the upper cross member 4, but is shown arranged on top of the upper cross member 4 for clarity.

The signal processing circuit 16 transfers a voltage to the strain gauge 13, and when this is affected by a pressure against the side post 2, then the signal processing circuit will record the pressure, and when the pressure exceeds a certain value, the value will be indicated by a light-emitting diode, a sound or another suitable signal.

Expediently, the signal processing circuit is connected to a battery 19 by wires 17, 18, which provides the advantage that a barrier may be mounted also where power is not available.

To ensure that a sufficient power supply is constantly provided to the battery, a circuit monitoring the battery may be arranged in the signal processing circuit, so that an alarm is given from the signal processing circuit in the event that the battery needs replacement.

Although the invention has been described with a special type of child safety barrier, nothing, of course, prevents the principles of the invention from applied within the scope defined by the claims also in connection with other child safety barriers where pressure impact is used for safe closing of the child safety barrier.

1. A child safety barrier (1), which is formed by a gate having an upper cross member (4) and a lower cross member (5), said upper cross member being connected with the lower cross member by a plurality of barrier bars (6), said upper cross member (4) being provided with upper ferrules (9, 10) at its ends, at least one ferrule (9) of which being secured to a rod which is movable relative to the upper cross member (4), and whose movement is provided by the operation of a handle (8), said movement of the rod causing the gate to be firmly fixed in an opening, e.g., defined by side posts (2, 3), said child safety barrier (1) having a pressure indicator (13) which is adapted to show whether the child safety barrier is fixed sufficiently in the opening or the frame, characterized in that wherein the pressure indicator is a pressure transducer (13) which is disposed on one of the ferrules (9, 10).

2. A child safety barrier according to claim 1, wherein the pressure transducer is a strain gauge (13).

3. A child safety barrier according to claim 2, wherein the strain gauge (13) is powered from a battery (19) positioned inside the upper cross member (4), and that wires (14, 15) between the strain gauge (13) and the battery (16) are run inside the upper cross member (4).

4. A child safety barrier according to claim 2, wherein the voltage detected by the strain gauge (13) is supplied to a display unit showing the amount of force with which the upper cross member (4) is fixed in the opening.

5. A child safety barrier according to claim 4, wherein the display unit shows the status of the voltage of the battery (19), and that an alarm signal is given if the voltage gets below a given minimum value.
